(19) United States
(12) Patent Application Publication
(10) Pub. No.: US 2011/0256819 A1
(43) Pub. Date: Oct. 20, 2011

(54) GAME FIELD DRESSING DOUBLE BLADE BONE SAW

(76) Inventor: John Sewell, Chico, CA (US)

(21) Appl. No.: 12/764,065

(22) Filed: Apr. 20, 2010

(51) Int. Cl. A22C 17/00; B26B 11/00; B26B 1/02; A22B 5/20

(52) U.S. Cl. 452/117; 452/164; 7/158; 30/155

(57) ABSTRACT

Two bone sawing blades are attached in a spaced parallel alignment and attached to a handle for cutting out a section of a pelvic bone in field dressing a game animal. A pivoting handle with a side opening enables the double blades to be pivoted into the handle for storage. A rigid handle is attached to the blades by a hand shield.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to bone cutting saws and in particular to a double bladed bone cutting field dressing saw for cutting the pelvic bone of a large game animal, the double blade saw comprising a handle and two bone sawing blades spaced apart which allow a larger opening to be cut in the pelvic bone with a single pass thereby allowing easier removal of the colon, bladder and guts and prevent puncturing them, and making it easier to clean the pelvic area.

2. Description of Related Art Including Information Disclosed Under 37 CFR 1.97 and 1.98

Many hunters use straight-bladed knives in the large game field dressing process. However, these knives are not configured for the types of cuts required, and require great skill on the part of the hunter to quickly and cleanly dress an animal. Furthermore, conventional knives—even hunter's knives and sportsmen's knives—have relatively long, thin blades which cannot easily cut through the bones and sinews of large game animals. Prior art bone saws are single blade saws and do not create a large enough opening through the pelvic bone to allow removal of the colon, bladder and guts without puncturing them.

U.S. Pat. No. 1,203,869, issued Nov. 7, 1916 to Hale, shows a corn and callous remover which comprises two thin saw blades with serrated edges parallel and flush with each other. The blades are spaced apart by interposed washes and held together using a rivet or screw.

U.S. Pat. No. 1,497,577, issued Jun. 10, 1924 to Morzsa, claims a saw having two support bars extending from its handle. An outer saw blade is located on the outer side of each of the support bars and an intermediate saw blade rests in between the two support bars.

U.S. Pat. No. 7,578,731, issued Aug. 25, 2009 to Moore, discloses a field dressing knife suitable for all aspects of field dressing small and large game. Various novel aspects of the knife include: a large butt-end of the handle and a groove near the butt-end of the handle, both to spread the normal stress over a larger surface area when striking the butt-end of the handle with a free hand for splitting pelvis and brisket bones; and a configurable handle, permitting the double-edged field dressing knife to be used in knife mode or in a hatchet mode.

U.S. Pat. No. 5,320,576, issued Jun. 14, 1994 to Sagen, shows a one-person-powered handsaw constructed precisely to sever the pelvis bone of a deer species while providing protection against puncturing the large intestine when field-dressing the animal.

U.S. Pat. No. 6,715,209, issued Apr. 6, 2004 to Taylor et al, describes a folding cutting tool which includes a handle having gripping depressions and a plurality of cutting blades. The blades are rotatably connected to the ends of the handle to allow them to be folded into the handle or extend from the handle during operation of the tool. At least one blade has at least one depression that aligns with a depression on the handle. Alternatively, the blades of the tool may fold far enough into the handle to not interfere with the depressions in the handle. The depressions allow for the user to adequately grip the handle to perform a cutting operation.

U.S. Pat. No. 7,487,565, issued Feb. 10, 2009 to Sundling et al, indicates a hunting multi-tool with a base frame having a handle and a drag bar. A first blade is coupled with the base frame and may be moved between skinning and gutting positions. A drag line depends from the drag bar and may be secured to a cleat coupled with the base frame. Second and third blades may be pivotably extended from the handle portion and covered with a handle cover when not in use.

U.S. Pat. No. 1,487,381, issued Mar. 18, 1924 to Helms, is for an adjustable grooving device which comprises a double saw.

Two U.S. Pat. Nos. 1,421,052 issued Jun. 27, 1922 and 1,228,728 issued Jun. 5, 1917 to White, provide a dado saw in which two blades are held in spaced relation from each other by clamping means.

U.S. Pat. No. 6,578,271, issued Jun. 17, 2003 to Macek, puts forth a gutting knife including a blade with two forward extensions that define a slot between them and a peripheral cutting edge defined around the sides and bottom of the slot. A first extension has a spike tip and a cutting edge along its outside. A second extension has a blunt tip or bulge which does not cut. A meander pathway along the second extension into the slot. Saw teeth into the slot on the first extension. A recess on the outside of the second extension is inclined rearwardly and includes a cutting edge. A handle is at the rear of the knife blade.

Two U.S. Pat. Nos. 4,528,751 issued Jul. 16, 1985 and 4,461,080 issued Jul. 24, 1984 to Olson, concern an eviscerating and survival tool having a shaft with a handle at one end, a claw-like hook at the other end, the hook being comprised of at least two arcuately shaped tines defining a slot, and a saw blade disposed longitudinally along the portion of the shaft near the end containing said hook. In its preferred form the shaft is in two approximately equal portions connected by pivotable fastening means to permit the two parts of the shaft to be folded against each other with means to maintain the two parts in rigid end-to-end relationship in use.

U.S. Pat. No. 5,462,479, issued Oct. 31, 1995 to Hajek, indicates a wild game dressing tool that is light in weight and small in size, comprising two handles connected by a saw blade for field dressing a deer or the like: the tool offers a quick, safe, and easy way to split an animal's pelvic bone, allowing better cleaning of the anal area and thereby resulting in more consistent, high quality meat.

Two U.S. Patent Applications, #20080313911 published Dec. 25, 2008 and #20060070502 published Apr. 6, 2006 by Phipps, illustrate a hunting knife for assisting a hunter in field dressing an animal, particularly for assistance with breaking the pelvic bone of the animal. The knife includes a handle, a single blade and an extended element. The longitudinal axis of the knife and the longitudinal axis of the extended element are disposed generally parallel and co-planar, as defined herein. A forward-receiving slot is formed between the blade and the extended element for receiving a portion of the pelvic bone of the animal. The invention includes sheaths for containing the knife of the invention. A method for using the knife of the invention includes the steps of contacting the knife to the portion of the pelvic bone desired to be broken and pulling up on the knife so as to break the bone.

What is needed is a field dressing bone cutting saw which easily cuts out a section of the pelvic bone to provide a sufficiently wide opening for the colon, bladder and guts of the game animal to be removed without puncturing them and for easier cleaning of the pelvic area.

### BRIEF SUMMARY OF THE INVENTION

An object of the present invention is to provide a bone cutting saw with rigidly connected parallel bone cutting blades spaced apart for a field dressing bone cutting saw which easily cuts out a section of the pelvic bone to provide a sufficiently wide opening for the colon, bladder and guts of the game animal to be removed without puncturing them and for cleaning of the pelvic area.

In brief, the present invention provides a double bladed bone cutting field dressing saw for cutting the pelvic bone of a large game animal. The double blade saw comprises a handle and two bone sawing blades spaced apart which allow a larger opening to be cut in the pelvic bone with a single pass thereby allowing easier removal of the colon, bladder and guts and prevent puncturing them and providing easier cleaning of the pelvic area.

A rigidly connected handle with a hand protector is attached to the double bone sawing blades in one embodiment. Another embodiment provides a handle with a blade storing opening pivotally attached to the double bone sawing blades to allow the blades to be pivoted out into alignment with the handle for use and pivoted back into the handle for storage. An optional gutting hook and hide cutting blade may also be pivotally attached.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a perspective view of the double blade field dressing bone saw of the present invention having a hand guard connecting the rigid handle to the pair of bone sawing blades;

FIG. 2 is a perspective view of the double blade field dressing bone saw of the present invention having a pivot between the handle and the pair of bone sawing blades and a blade storage interior in the handle so that the blades pivot into the handle for storage, and showing an additional pivoting knife blade and optional pivoting gutting hook;

FIG. 3 is a perspective view of the double blade field dressing bone saw of FIG. 2 having the pair of bone sawing blades, and the knife blade and the optional gutting hook all pivoted into blade storage interior in the handle for storage;

FIG. 4 is a perspective view of the double blade field dressing bone saw of FIG. 2 having the pair of bone sawing blades pivoted open for use with an internal organ shielding paddle;

FIG. 5 is a perspective view of the double blade field dressing bone saw of the present invention having a separate pivot between the handle and each of the pair of bone sawing blades and a blade storage interior in the handle so that the blades pivot independently into the handle for storage, and an additional pivoting knife blade, showing one of the pair of saw blades in the pivoted out position for use and the other of the pair of saw blades pivoted into the blade storage interior of the handle;

FIG. 6 is a perspective view of the double blade field dressing bone saw of FIG. 5 having a separate pivot between the handle and each of the pair of bone sawing blades and a blade storage interior in the handle so that the blades pivot independently into the handle for storage, and an additional pivoting knife blade, showing both of the pair of saw blades in the pivoted out position for use together.

### DETAILED DESCRIPTION OF THE INVENTION

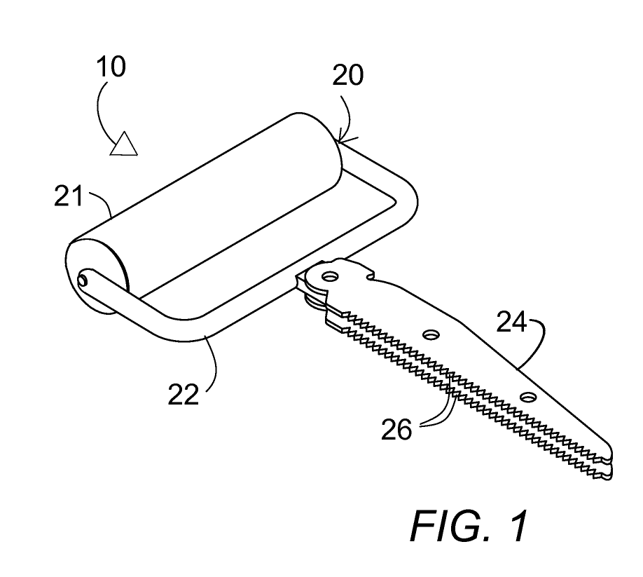

In FIGS. 1-6, a double blade field dressing saw device 10 and 10A is used for cutting an organ removal opening through the pelvic bone of a large game animal. The device comprises a double blade bone cutting saw 20 and 20A having a pair of bone cutting blades 24 and 24A attached to a handle 21 and 21A.

In FIGS. 1, 2, and 4, the double blade saw 20 and 20A comprises a pair of bone sawing blades 24 and 24A attached together in a parallel spaced alignment with the bone cutting teeth 26 of the pair of bone sawing blades forming two parallel rows of teeth in spaced alignment forming a dual spaced array of teeth to saw together simultaneously. The pair of bone sawing blades 24 and 24A are spaced apart by a distance to saw away a section of a pelvic bone of a large game animal in a single sawing action in the field to create a gap in the pelvic bone sufficiently large to allow removal of the internal organs of the large game animal without perforating the internal organs.

The handle 21 and 21A is secured to the double bone sawing blades 24 and 24A so that a user grasps the handle to impart a sawing motion to the double bone sawing blades on the pelvic bone to saw away a section of the pelvic bone to provide an organ removal opening through the pelvic bone of the large game animal.

In FIG. 1, the handle 21 comprises the handgrip portion 21 in vertical alignment with the plane of the pair of bone sawing blades 24 and perpendicular to the two parallel rows of teeth 26, and a hand guard portion 22 rigidly connecting the handgrip portion to the pair of bone sawing blades 24.

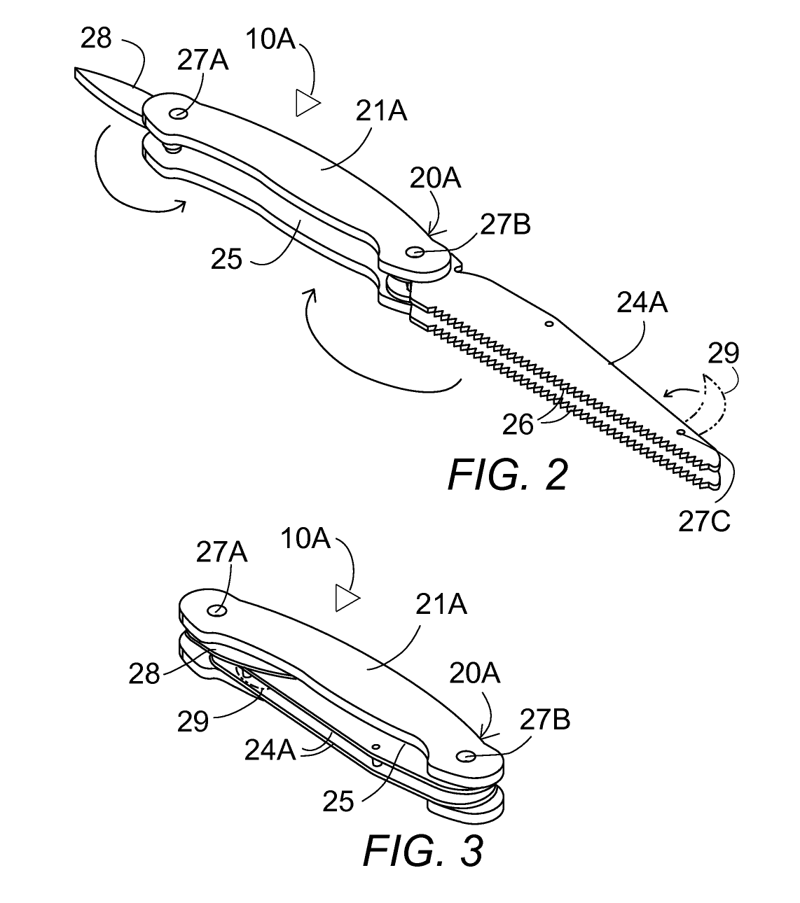

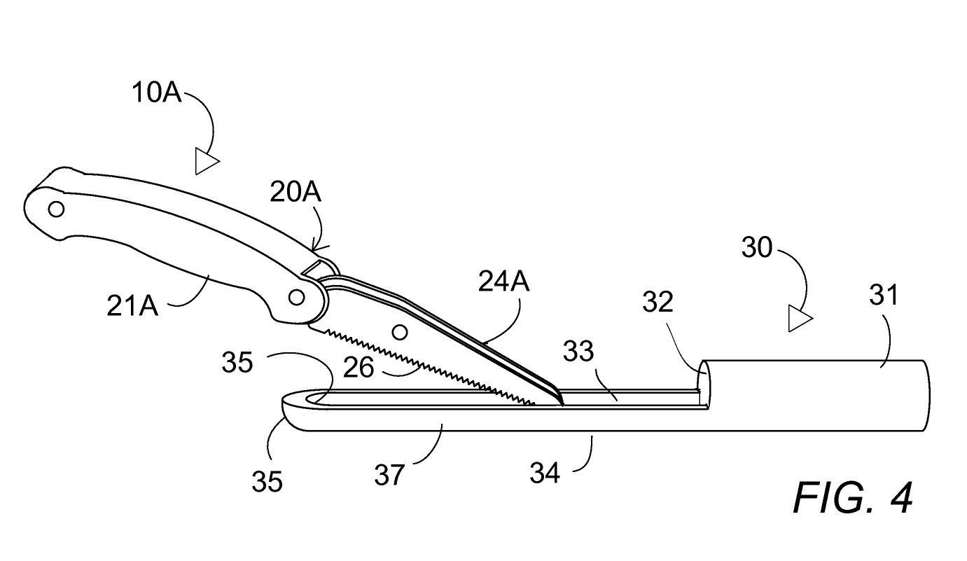

In FIGS. 2-4, the handle 21A comprises a handgrip portion 21A attached by a pivot connection 27B to the pair of bone sawing blades 24A. The handgrip portion 21A has an elongated opening 25 along one edge so that the pair of bone sawing blades 24A in a first position, as shown in FIGS. 2 and 4, is pivoted out into linear alignment with the handgrip portion for use and alternately in a second position, shown in FIG. 3, pivoted into the elongated opening for storage within the handgrip portion 21A.

In FIG. 2, a knife blade 28 is pivoted out into linear alignment with the handgrip portion 21A for use in cutting the game animal hide in a first position and alternately, in FIG. 3, pivoted into the elongated opening 25 for storage within the handgrip portion 21A in a second position.

An optional gutting hook 29 may be attached by a pivot connector 27C to the bone cutting blades 24A. The gutting hook 29 is pivoted out into perpendicular alignment with the bone cutting blades for use is slicing open the animal hide for gutting the game animal in the field in a first position, as shown in FIG. 2 and alternately pivoted in between the bone cutting blades 24A for storage in a second position, as in FIG. 3.

In FIG. 4, the double bone saw device 10A is shown in use with an internal organ shielding paddle 30 comprising an elongated paddle blade 34 having a convexly curved point 36 on a distal end and an elongated transverse convexly curved bottom 37 along the length of the paddle blade to provide a smooth surface for ease of insertion of the paddle blade under the pelvic bone of the game. A semi-circular trough 33 is recessed into a top surface of the paddle blade along the length of the blade with an end stop 35 and a handle stop 32 to receive the pair of bone sawing blades 24A within the trough to guide the pair of bone sawing blades and to restrict the movement of the bone sawing blades therein to prevent the pair of bone sawing blades from puncturing the internal organs when sawing through the pelvic bone. The paddle blade 34 is attached to a paddle handle 31 to grasp for inserting and holding the paddle blade.

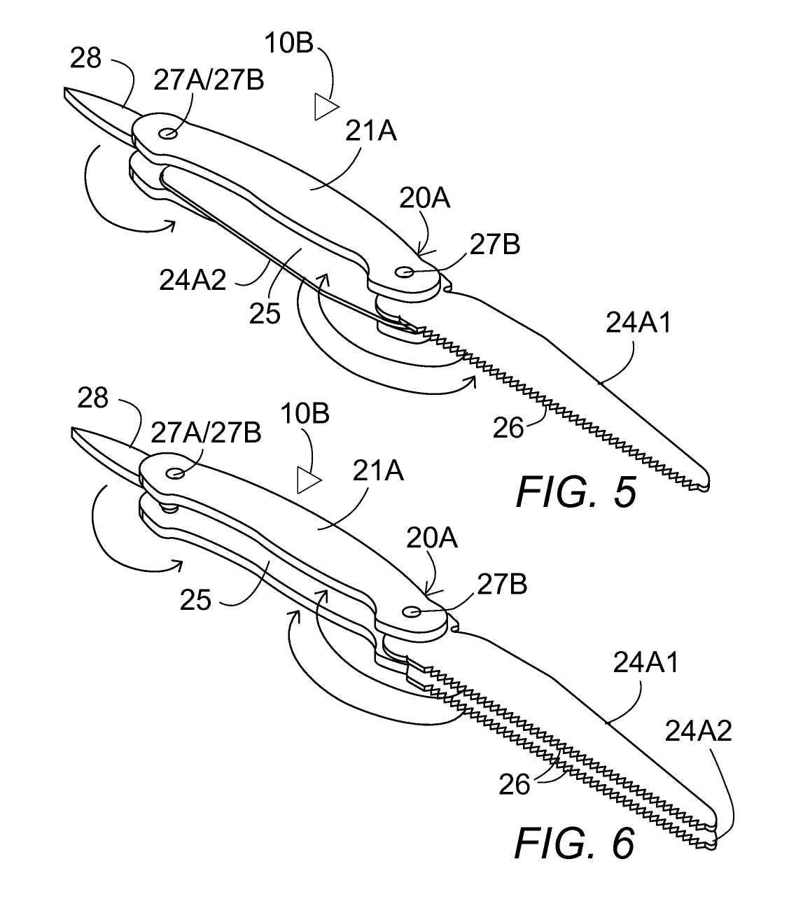

In FIGS. 5 and 6, the double blade field dressing bone saw 10B of the present invention has a separate pivot 27A and 27B between the handle and each of the pair of bone sawing blades 24A1 and 24A2 and a blade storage interior 25 in the handle so that the blades pivot independently into the handle for storage, and an additional pivoting knife blade 28. In FIG. 5, one saw blade 24A1 of the pair of saw blades in the pivoted out position for use, as in sawing branches or other general sawing usage, and the other saw blade 24A2 of the pair of saw blades is pivoted into the blade storage interior 25 of the handle 21A. In FIG. 6, both of the pair of saw blades 24A1 and 24A2 are in the pivoted out position for use together in sawing and removing a segment of the pelvic bone with a single pass of the dual saw blades.

It is understood that the preceding description is given merely by way of illustration and not in limitation of the invention and that various modifications may be made thereto without departing from the spirit of the invention as claimed.

What is claimed is:

1. A double blade field dressing saw device for cutting an organ removal opening through the pelvic bone of a large game animal, the device comprising:
a double blade bone cutting saw comprising a pair of bone sawing blades attached together in a parallel spaced alignment with the bone cutting teeth of the pair of bone sawing blades forming two parallel rows of teeth in spaced alignment forming a dual spaced array of teeth to saw together simultaneously, the pair of bone sawing blades spaced apart by a distance to saw away a section of a pelvic bone of a large game animal in the field in a single sawing action to create a gap in the pelvic bone sufficiently large to allow removal of the internal organs of the large game animal without perforating the internal organs;
a handle secured to the double bone sawing blades so that a user grasps the handle to impart a sawing motion to the double bone sawing blades on the pelvic bone to saw away the section of the pelvic bone to provide a double blade field dressing saw device for cutting an organ removal opening through the pelvic bone of a large game animal.

2. The device of claim 1 wherein the handle comprises a handgrip portion in vertical alignment with the plane of the pair of bone sawing blades and perpendicular to the two parallel rows of teeth, and a hand guard portion connecting the handgrip portion to the pair of bone sawing blades.

3. The device of claim 1 wherein the handle comprises a handgrip portion attached by a pivot connection to the pair of bone sawing blades, the handgrip portion having an elongated opening along one edge so that the pair of bone sawing blades are pivoted out into linear alignment with the handgrip portion for use in a first position and alternately position pivoted into the elongated opening for storage within the handgrip portion in a second position.

4. The device of claim 3 further comprising a knife blade pivoted out into linear alignment with the handgrip portion for use in a first position and alternately pivoted into the elongated opening for storage within the handgrip portion in a second position.

5. The device of claim 3 further comprising a gutting hook attached by a pivot connector to the bone cutting blades, the gutting hook pivoted out into perpendicular alignment with the bone cutting blades for use in a first position and alternately pivoted in between the bone cutting blades for storage in a second position.

6. The device of claim 1 further comprising an internal organ shielding paddle comprising an elongated paddle blade having a convexly curved point on a distal end and an elongated bottom having a transverse convexly curved bottom along the length of the paddle blade to provide a smooth surface for ease of insertion of the paddle blade under the pelvic bone of the game and a semi-circular trough into a top surface of the paddle blade along the length of the blade to receive the pair of bone sawing blades within the trough to guide the pair of bone saw blades and to prevent the pair of bone sawing blades from puncturing the internal organs when sawing through the pelvic bone, the paddle blade attached to a paddle handle to grasp for inserting and holding the paddle blade.
